(19) United States
(12) Patent Application Publication
(10) Pub. No.: US 2016/0055275 A1
(43) Pub. Date: Feb. 25, 2016

(54) LARGE SCALE FLIGHT SIMULATION

(71) Applicants: Mengjiao Wang, Shanghai (CN); Chenjun Yang, Shanghai (CN); Wen-Syan Li, Fremont, CA (US)

(72) Inventors: Mengjiao Wang, Shanghai (CN); Chenjun Yang, Shanghai (CN); Wen-Syan Li, Fremont, CA (US)

(21) Appl. No.: 14/465,239

(22) Filed: Aug. 21, 2014

(51) Int. Cl. G06F 17/50

(52) U.S. Cl. CPC G06F 17/5009

(57) ABSTRACT

This disclosure generally relates to devices, systems, and computer-implemented methods for simulating flights. Specifically, methods are described that comprise the operations of receiving flight information for one or more flights to be simulated; receiving historical flight information for historical flights; determining, based on the flight information and the historical flight information, probabilities for one or more flight parameters of the one or more flights to be simulated; determining a current state of the one or more flights to be simulated based on the determined probabilities for the one or more flight parameters; determining a next state of the one or more flights to be simulated based on the current state; and outputting one or more evaluation parameters associated with the next state of the one or more flights to be simulated.

### TECHNICAL FIELD

The present disclosure relates to computer-implemented methods, devices, and systems for providing a model that models flight-related parameters for one or more flights to be simulated.

### BACKGROUND

Air traffic becomes more and more congested due to the increase of demand. The workload in air traffic control centers is extremely high during the peak hours. A congested situation could cause many negative effects such as flight delays and cancellations, or even an increased probability of flight collisions. Thus, evaluation of the status of air traffic before the scheduled flights departure is important to both air traffic controllers and airline companies.

Evaluating flight schedules is a difficult task as there are many random factors such as weather, airport condition, and aircraft status. All of those factors could have significant influences on flight schedules. Thus, a need exists for a flight simulation system that is able to simulate a large number of aircrafts in given areas, showing the statistical status of each aircraft, each airport, and each flight route.

### SUMMARY

The present disclosure relates to computer-implemented methods, devices and systems for providing a model that simulates flight-related parameters based on probabilistic decision trees and Markov chains.

One or more of the following aspects of this disclosure can be embodied as methods that include the corresponding operations. One or more of the following aspects of this disclosure can be implemented in a device comprising a processor, a computer-readable medium coupled to the processor having instructions stored thereon which, when executed by the processor, cause the processor to perform operations according to the one or more of the following aspects. One or more of the following aspects of this disclosure can be implemented on a computer-readable medium having instructions stored thereon that, when executed by a processor, cause the processor to perform operations according to the one or more of the following aspects.

In a general aspect 1, a computer-implemented method for simulating flights, the

method comprising receiving flight information for one or more flights to be simulated; receiving historical flight information for historical flights; determining, based on the flight information and the historical flight information, probabilities for one or more flight parameters of the one or more flights to be simulated; determining a current state of the one or more flights to be simulated based on the determined probabilities for the one or more flight parameters; determining a next state of the one or more flights to be simulated based on the current state; and outputting one or more evaluation parameters associated with the next state of the one or more flights to be simulated.

Aspect 2 according to aspect 1, wherein the flight information includes at least one of: aircraft information, flight schedule information, airport information, flight route information, or weather information

Aspect 3 according to any one of aspects 1 to 2, wherein the historical flight information includes at least one of the following information for historical flights: aircraft information, flight schedule information, airport information, flight route information, or weather information.

Aspect 4 according to aspect 3, wherein the weather information includes at least one of the following information associated with a portion of the flight route of the historical flight: wind speed, wind direction, air pressure, cumulonimbus, or temperature.

Aspect 5 according to any one of aspects 1 to 4, wherein the probabilities are determined using a probabilistic decision tree model.

Aspect 6 according to any one of aspects 1 to 5, wherein the next state of the one or more flights to be simulated is determined based only on the current state, or wherein the next state of the one or more flights to be simulated is determined based on the current state according to a Markov chain model.

Aspect 7 according to any one of aspects 1 to 6, the method further comprising automatically performing at least one of: moving a real flight to another time slot, adding a new real flight route, or increasing a capacity of a real airport.

Aspect 8 according to any one of aspects 1 to 7, wherein the state includes one or more of the following information associated with the one or more flights to be simulated: airport status, flight route status, aircraft status, or weather status.

Aspect 9 according to any one of aspects 1 to 8, wherein one or more evaluation parameters include at least one or more of the following parameters associated with the one or more flights to be simulated: aircraft gas consumption, flight delay with respect to flight schedule, number of conflicts between aircrafts, weather condition, or airport occupancy.

Aspect 10 according to any one of aspects 1 to 9, wherein one or more flight parameters include at least one or more of the following parameters associated with the one or more flights to be simulated: aircraft speed, aircraft direction of propagation, wind speed affecting the aircraft during propagation, flight level, or airport occupancy.

Aspect 11 according to any one of aspects 1 to 10, wherein the next state is temporally shifted to a later time with respect to the current state.

### DESCRIPTION OF DRAWINGS

FIG. 1 illustrates an example distributed computing system for providing a flight simulation.

FIG. 2A illustrates an exemplary flight route from airport A to airport B.

FIG. 2B illustrates multiple exemplary parameters that may be taken into account for the flight simulation.

FIG. 3 illustrates an exemplary system design of large scale flight simulation.

FIG. 4A illustrates an exemplary probabilistic decision tree model that determines probabilities for flight parameters based on historical flight information.

FIG. 4B illustrates an exemplary Markov chain model for determining a next state of the flight based on a current state of the flight.

FIG. 5 illustrates an exemplary method for simulating one or more flights.

FIG. 6A illustrates an exemplary simulation output for one or more simulated flights.

FIG. 6B illustrates an exemplary simulation output for one or more simulated flights, in particular a delay distribution of a flight of one thousand runs.

Reference numbers and designations in the various drawings indicate exemplary aspects, implementations or embodiments of particular features of the present disclosure.

### DETAILED DESCRIPTION

There may be difficulties in building an evaluation and simulation system for air traffic status:
1. A flight could be delayed or canceled for various reasons, such as mechanical fault, air traffic control, weather, or even a war can happen in a specific area.
2. There is a large number of aircrafts flying in the sky at the same time.
3. The weather may have impact on air traffic, however, the long term weather forecasting is still a unsolved problem.
4. Different airports have different capacities, different regulations, and different weather conditions.
5. Airline companies or flight dispatchers may use a wide range of aircrafts. Each aircraft may have different speed, flight level, weight, oil consumption, and other factors.

This disclosure generally relates to devices, systems, and methods for providing a model that simulates flight-related parameters based on probabilistic decision trees and Markov chains. Specifically, this patent application describes a flight schedule simulation system that is able to simulate a large number of aircrafts in given areas, taking into account the technical status of each aircraft, weather conditions, airport conditions, and flight route parameters.

The subject-matter described in this disclosure can be implemented in particular aspects or embodiments so as to realize one or more of the following example advantages, as well as others recognizable to one of skill in the art.

First, the simulation system is able to flexibly augment the number of flights simulated in parallel and can be scaled to a large number (e.g. 100,000 and more) flights.

Second, the simulation is robust with respect to (pseudo-)random events such as weather changes or airport status changes.

Third, the simulation can be adjusted for new aircrafts, flight routes, and airports.

Fourth, the simulation can assist a researcher or developer in the field of air traffic control, aircraft development, or airport management in improving resource consumption, time consumption, conflict management, or passenger throughput. The output of the simulation may be directly fed back to an aircraft, an airport or a flight controller for making adjustments to the flight the aircraft or the airport associated with one or more flights that are simulated.

Fifth, the simulation uses robust simulation techniques including (i) a probabilistic decision tree model to generate random events and decisions and (ii) the discrete-time Markov chain to model the state transitions of aircraft, airport, and weather.

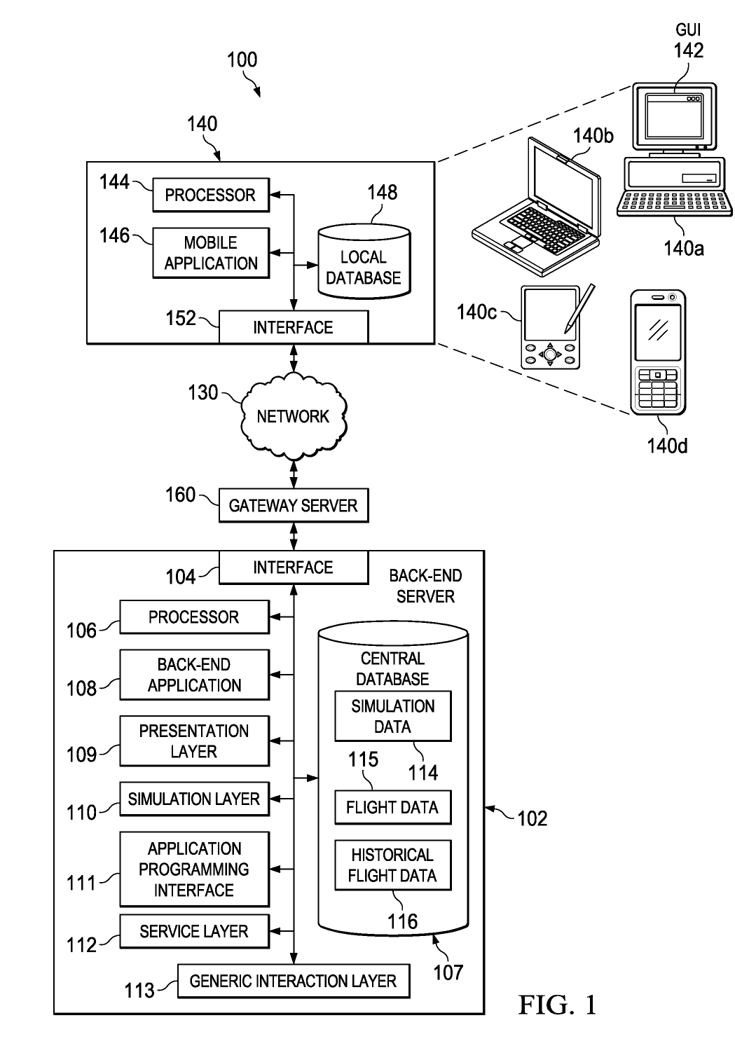

FIG. 1 illustrates an example distributed computing system 100 operable to provide a flight simulation on user devices according to one aspect of the disclosure. Specifically, the illustrated example distributed computing system 100 includes or is communicably coupled with a back-end server 102 (e.g., an enterprise services repository (ESR) server) and a user device 140 which may communicate across a network 130.

In general, the back-end server 102 is a server that stores one or more back-end applications 108 (e.g., an ESR application, an enterprise resource planning (ERP) application, etc.), where at least a portion of the back-end applications 108 are executed via requests and responses sent to users or clients within and communicably coupled to the illustrated example distributed computing system 100. In some implementations, the back-end server 102 may store a plurality of various back-end applications 108. In other implementations, the back-end server 102 may be a dedicated server meant to store and execute only a single back-end application 108. In some implementations, the back-end server 102 may comprise a web server, where the back-end applications 108 represent one or more web-based applications accessed and executed by the user device 140 via the network 130 or directly at the back-end server 102 to perform programmed tasks or operations of the back-end application 108.

At a high level, the back-end server 102 comprises an electronic computing device operable to receive, transmit, process, store, or manage data and information associated with the example distributed computing system 100. Specifically, the back-end server 102 illustrated in FIG. 1 is responsible for receiving application requests, for example simulation requests, from one or more mobile applications 146 associated with the user device 140 of the example distributed computing system 100 and responding to the received requests by processing said requests in the associated back-end application 108, and sending the appropriate response from the back-end application 108 back to the requesting mobile application 146. In addition to requests from the user device 140, requests associated with the back-end applications 108 may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single back-end server 102, environment 100 can be implemented using two or more servers 102, as well as computers other than servers, including a server pool. Indeed, back-end server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated back-end server 102 may be adapted to execute any operating system, including Linux, UNIX, Windows, Mac OS, Java, Android, iOS or any other suitable operating system. According to one implementation, back-end server 102 may also include or be communicably coupled with an e-mail server, a web server, a caching server, a streaming data server, and/or other suitable server.

The back-end server 102 also includes an interface 104, a processor 106, and a central database 107. The interface 104 is used by the back-end server 102 for communicating with other systems in a distributed environment—including within the environment 100—connected to the network 130; for example, the user device 140, as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

As illustrated in FIG. 1, the back-end server 102 includes a processor 106. Although illustrated as a single processor 106 in FIG. 1, two or more processors may be used according to particular needs, desires, or particular implementations of the environment 100. Each processor 106 may be a central processing unit (CPU), a blade, an application specific integrated circuit (ASIC), a field-programmable gate array (FPGA), or another suitable component. Generally, the processor 106 executes instructions and manipulates data to perform the operations of the back-end server 102. Specifically, the processor 106 executes the functionality required to receive and respond to requests from the user device 140 and/or allowing providing flight simulations on user device 140.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Objective C, Java, Visual Basic, assembler, Perl, any suitable version of 4GL, industry standard language, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The back-end server 102 also includes the central database 107, or multiple central databases 107. The central database 107 may include any type of memory or database module and may take the form of volatile and/or non-volatile memory including, without limitation, magnetic media, optical media, random access memory (RAM), read-only memory (ROM), removable media, or any other suitable local or remote memory component. The central database 107 may store various objects or data, including caches, classes, frameworks, applications, backup data, jobs, web pages, web page templates, entities in industry standard language, database tables, repositories storing business and/or dynamic information, and any other appropriate information including any parameters, variables, algorithms, instructions, rules, constraints, or references thereto associated with the purposes of the back-end server 102. Additionally, the central database 107 may include any other appropriate data, such as VPN applications, firmware logs and policies, firewall policies, a security or access log, print or other reporting files, as well as others. While central database 107 is illustrated as in integral component of the back-end server 102, in alternative aspect or implementation central database 107 can be external to the back-end server 102 and/or the example distributed computing system 100.

The back-end server 102 further includes an application programming interface (API) 111. The API 111 may include specifications for routines, data structures, and object classes. The API 111 may be either computer language independent or dependent and refer to a complete interface, a single function, or even a set of APIs. In some implementations, the API 111 can be used to interface between the back-end application 108 and/or one or more components of the back-end server or other components of the example distributed computing system 100, both hardware and software. For example, in one implementation, the back-end application 108 can utilize API 111 to communicate with the user device 140. Although the API 111 is shown as a stand-alone component within the back-end server 102, there may be multiple other APIs in the example distributed computing system 100 that are integrated into or accessible by individual components, both hardware and software. The back-end server 102 (e.g., an ESR server) may be based on a Java platform and/or the back-end application may be based on a Java runtime environment. In an aspect, the term “platform” or “technology” is understood to be at least one of operating system, hardware infrastructure and software development platform. In an implementation of the present disclosure described herein, the term “platform” or “technology” is understood as types of Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC). In an implementation of the present disclosure described herein, the term “technology” comprises ByDesign platform, Success Factors Platform, ERP Suite technology or in-memory database such as High Performance Analytic Appliance (HANA) platform.

The service layer 112 provides software services to the example distributed computing system 100. The functionality of the back-end server may be accessible for all service consumers via this service layer. Software services, such as flight simulations, provide reusable, defined business functionalities through a defined interface. The defined interface may be software written in extensible markup language (XML) or other suitable language. While illustrated as an integrated component of the back-end server 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module or enterprise application (not illustrated) or of another hardware module (not illustrated) without departing from the scope of this disclosure.

The central database 107, i.e., a back-end data system, holds data or metadata for the back-end server 102. In some implementations, the central database 107 includes an simulation data 114, flight data 115, and historical flight data 116. Although illustrated as single instances, there may be more than one instance of the data 114, 115, and/or 116.

In an aspect, the flight information 115 may include at least one of: aircraft information, flight schedule information, airport information, flight route information, or weather information. In an aspect, the historical flight information 116 may include at least one of the following information for the historical flights: aircraft information, flight schedule information, airport information, flight route information, or weather information. In an aspect, the simulation data 114 may include simulation results such as one or more evaluation parameters that may include at least one or more of the following parameters associated with the one or more flights to be simulated: aircraft gas consumption, flight delay with respect to flight schedule, number of conflicts between aircrafts, weather condition, or airport occupancy. In an aspect, the simulation data 114 may include simulation results such as one or more flight parameters which may include at least one or more of the following parameters associated with the one or more flights to be simulated: aircraft speed, aircraft direction of propagation, wind speed affecting the aircraft during propagation, flight level, or airport occupancy.

Access to the back-end server 102 may be provided through the user device 140, for example, via a web browser or other suitable GUI 142 application interfacing with the user interface (UI) presentation layer 109 that further interfaces with the application programming interface 111 provided by a simulation layer 110. The simulation layer 110 provides a consistent interface for a GUI application to access data 114, 115, 116 associated with the back-end application 108. Associated with the simulation layer 110 is a generic interaction layer 113 which provides a consistent interface for the simulation layer 110 to access back-end application 108 data 114 through APIs 111 and for the back-end application 108 to return data to the user device 140. At a high-level, generic interaction layer 113 may act as a bridge between the user device 140 and the back-end application 108. Because of this architecture, the user device 140 may not affected by changes to the underlying back-end application 108 as long as the simulation layer 110, generic interaction layer 113 or APIs 111 interface(s) does not change. This architecture also may ensure that changes to a particular layer, API, etc. can also be isolated from affecting other layers, APIs, etc. While described as a generic interaction layer 113, the interaction layer 113 may be proprietary or otherwise non-generic in other implementations.

User devices 140 may access the back-end server 102 through the gateway server 160. The gateway server 160 provides one or more defined APIs and acts as an interface or gateway between a user device 140 and the back-end server 102. In some implementations, the gateway server 160 can communicate with user device 140 using Open Data (OData) protocol through hypertext transfer protocol (HTTP) or hypertext transfer protocol secure (HTTPS) requests. In some implementations, the gateway server 160 can use a remote function call (RFC) interface to communication with advanced business application programming (ABAP) language and/or non-ABAP programs. In some implementations, the gateway server 160 can be stand-alone. In some implementations, the gateway server 160 can be incorporated into any component of the example distributed computing system 100. In some implementations the gateway server 160 may be a hardware server, a software server, and/or a virtual server. In some implementations, the gateway server 160 can be part of a web server, a streaming server, an RSS server, or other suitable server.

The illustrated user device 140 further includes a processor 144, a local database 148, an interface 152, and a mobile application 146. In a general aspect, the user device 140a-d may be a tablet computer, a smartphone, a cell phone, a personal digital assistant (PDA), an e-book reader, a laptop or desktop computer or similar mobile computing devices. The mobile application 146 allows the user device 140 to request and view content on the user device 140. In some implementations, the mobile application 146 can be and/or include a web browser. In some implementations, the mobile application 146 can use parameters, metadata, and other information received at launch to access a particular set of data from the server 102. Once a particular mobile application 146 is launched, a user can interactively process a task, event, or other information which may be associated with the back-end server 102. Further, although illustrated as a single mobile application 146, the mobile application 146 may be implemented as multiple mobile applications in the user device 140.

Customers (e.g., users of devices 140a-d) may run on-premise systems in hybrid landscapes together with on-demand systems, consuming data from both. Therefore, a set of tools that span across different platforms may be used to provide an easy and efficient development experience around OData. To do so, the flight simulation layer 110 may be built as a building block for the development of user-centric applications.

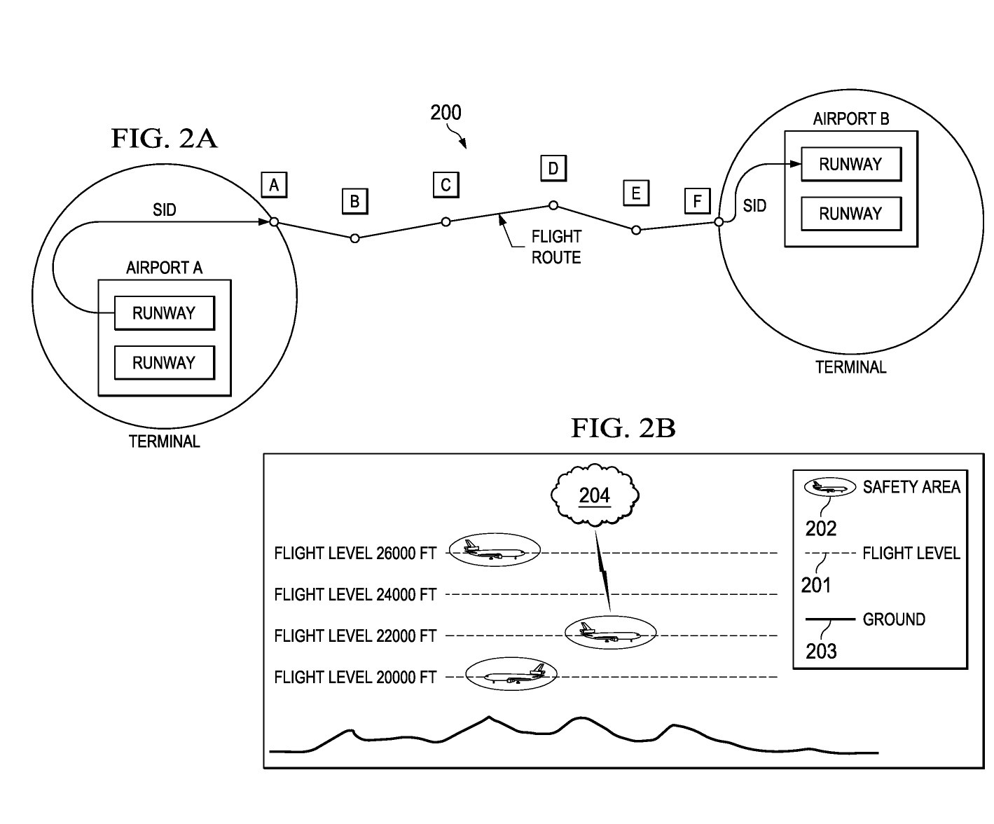

FIG. 2A illustrates an exemplary flight route from airport A to airport B. A flight departure from a runway of airport A may fly through the flight route 200: runway of airport A→standard instrument departure (SID)→A→B→C→D→E→F→SID→runway of airport B. It may be an object of the present application to provide a method for simulating such a flight route 200 based on input data provided for the one or more flights to be simulated. FIG. 2B illustrates that along the flight route 200, there may be multiple parameters that may be taken into account, such as flight level 201, safety areas 202 with respect to other aircrafts, ground level, 203, or weather conditions (e.g., wind, rain, thunder) 204.

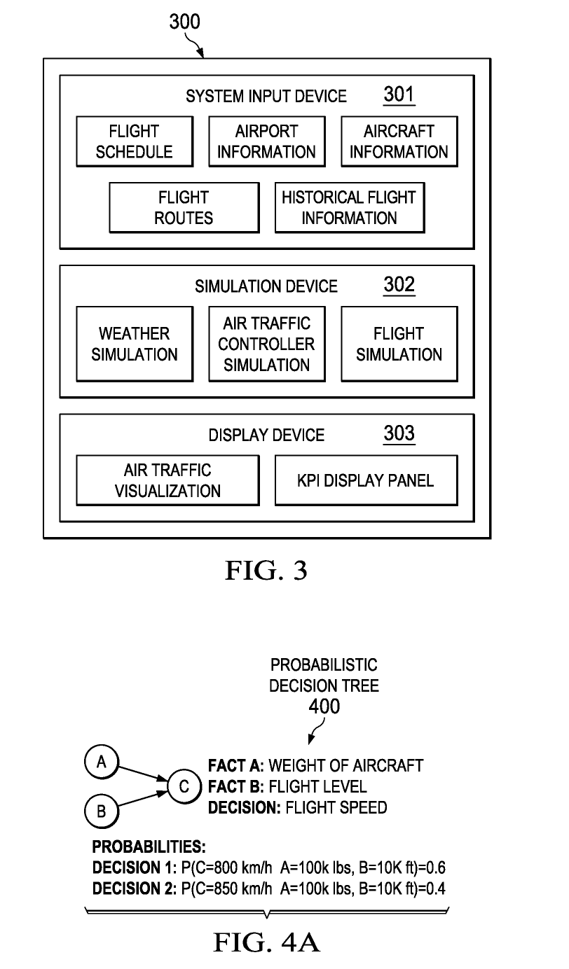

FIG. 3 illustrates an exemplary system design of large scale flight simulation. This simulation system 300 may be able to simulate a large number (e.g. 100,000 or more) of aircrafts in given areas, showing the statistical status of each aircraft, each airport, and each flight route. The system can be used as a useful tool to evaluate various factors, e.g., the safety, robustness, gas consumption, degree of delay, and degree of congestion of current and future flight schedules. The simulation system may include three core components: system input device 301, simulation device 302, and display device 303.

The input information for this system may include flight schedule, airport information, aircraft information, flight routes, and historical flight information. All the information required by this system may be available in current air traffic control system. The flight schedule information may include one or more of the following information: flight number, operator, aircraft, weight, oil or gas on board of the aircraft, departure airport, departure time, arrival airport, or arrival time. The airport information may include one or more of the following information: airport code, the number of runways, standard departure routes, or standard arrival routes. The aircraft information may include one or more of the following information: aircraft model, manufactory, maximum flight level, or maximum speed. The flight routes information may include one or more of the following information: flight points, route width, allowed flight levels, the minimum safety area (e.g. horizontal and/or vertical distance to the next aircraft), maximum speed, or minimum speed. For example, the input flight information may include at least one of: aircraft information, flight schedule information, airport information, flight route information, or weather information. The historical flight information may include a combination of one or more of the following information of historical flights: flight schedule, airport information, aircraft information, flight route information and weather information. The weather information may include historical flight route weather, or historical airport weather. The historical weather considered in this system may include one or more of the following: wind speed, wind direction, air pressure, cumulonimbus, or temperature.

The simulation device 302 may include three sub-components: weather simulation, air traffic controller simulation, and flight simulation. The simulation may first learn the statistical distributions from historical data and then may generate random events according to this distribution. The weather simulation may consider the weather in a complete route from departure airports to the arrival airports. Both the airport weather and flight weather may be pseudo-randomly generated according to historical weather data. The air traffic controller may play a very important role in air traffic control. The flight may follow the rules and commands that are sent from an air traffic controller. At least two kinds of strategy to simulate air traffic controller may be used: (1) first-come-first-serve or (2) priority-based-serving. The flight simulation may, in some instances, primarily simulate the position and status of a flight. Usually an aircraft with a certain weight under a determined weather has its own economic speed and best flight level. The airline companies may be able to find the suitable speed and flight level. However, the aircraft sometime cannot fly with that suitable speed and flight level due to air traffic congestions and safety reasons. In simulation system 300, the economic speed and flight level from the historical data may first be estimated, and then an application to the air traffic controller component may be performed. Before making decisions, the air controller component may evaluate the congestions and safety distance.

The display device 303 may be any (e.g., graphical) user interface that is configured to output (e.g., show) flight states during the simulation, or playback after the simulation is done. In an aspect, the display device 303 is user device 140. For example, a researcher or developer using a mobile device 140 may access flight simulation results while performing development work associated with flights. System 300 does not require a specific display method, as long as the display fit the basic requirements for outputting evaluation parameters associated with the flight being simulated, such as safety, congestion, robustness, delay status of each flight route, each airport and each flight, average speed, capacity ratio, flight density, or the number of queuing in airports.

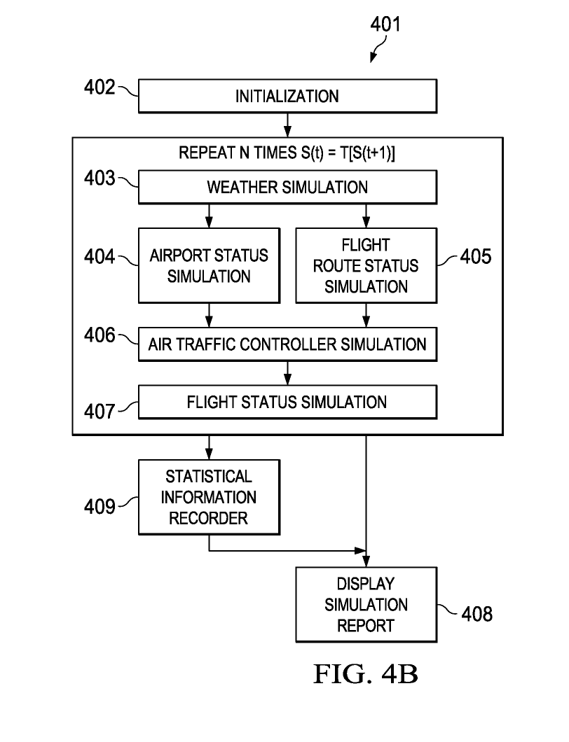

FIG. 4A illustrates an exemplary probabilistic decision tree model 400 that determines probabilities for flight parameters based on historical flight information. A decision tree model is a tree-like graph model of decisions and their possible consequence. A probabilistic decision tree makes decisions with a probability. For example, in FIG. 4A, when the weight of an aircraft and the flight level is determined or inputted, the flight speed is an random variable that depends on weight and flight level. The probability of such kind of random variables can be learned from historical data. In the simulation system 300, decisions are pseudo-randomly generated according to the probability distributions of each random variable. The decision tree model may be trained on historical flight information. The simulation device 302 may operate based on any decision tree model and is not limited to a particular type of decision tree model. The models employed can, for example, be based on any one of the so-called Iterative Dichotomiser 3 (ID3), C4.5, Classification and Regression Tree (CART), or CHi-squared Automatic Interaction Detection (CHAID) algorithms.

In an aspect, a computer-implemented method for simulating flights according to this application may comprise the following operations performed by one or more computing devices (e.g. system 300): receiving flight information (e.g., wind speed, weight of the aircraft, and/or flight level of the aircraft) for one or more flights to be simulated; receiving historical flight information for historical flights; and determining, based on the flight information and the historical flight information, probabilities for one or more flight parameters (e.g. flight speed) of the one or more flights to be simulated. In an aspect, the flight information includes at least one of: aircraft information, flight schedule information, airport information, flight route information, or weather information. In an aspect, the historical flight information includes at least one of the following information for the historical flights: aircraft information, flight schedule information, airport information, flight route information, or weather information. In an aspect, the weather information includes at least one of the following information associated with a portion of the flight route of the historical flight: wind speed, wind direction, air pressure, cloud characteristics, or temperature.

FIG. 4B illustrates an exemplary Markov chain model 401 for determining (e.g., by system 300) a next state of the flight based on a current state of the flight. The discrete-time Markov chain model is a random process that undergoes transitions from one state to another state. The next stated depends (e.g. only) on the current state according to the so-called Markov chain property. In this system, we use the discrete-time Markov chain model to describe the state of the whole system. The next state of the system (Sₜ₊₁) is transformed from the current state of the flight system Sₜ:

Sₜ₊₁=T(Sₜ)

The state of the system may include one or more of weather, airports status (Aₜ), flight routes status (Rₜ) and flights status Fₜ:

Sₜ={Aₜ, Rₜ, Fₜ}

The status of an airport (Aₜ) may include the number of available runways (AR), the number of flights waiting for departure (WFD), the minimum time interval for departures (TID), the number of flights waiting for landing (WFL), and the minimum time interval for landing (TIL).

Aₜ={AR, WFD, TID, WFL, TIL}

The status of a flight route (Rₜ) includes the number of flight levels allowed (FLA), the starting point (SP) and ending point (EP) of this route, the maximum speed (MaxSL) and minimum speed (MinSL) allowed in each level, the number of flights in each level (NFL), and the safety distance in each level (SDL). The indicators in flight route may be static in the flight system; however, some of them might change subject to the weather condition.

Rₜ={FLA, SP, EP, MaxSL, MinSL, NFL, SDL}

The status of a flight (Fₜ) may include the position of this flight (PF), the speed of this flight (FS), the flight level of this flight (FL), the heading angel of this flight (HA), and other basic information of this aircraft (ABI) such maximum speed, maximum flight level, departure, and current weight.

Fₜ={PF, FS, FL, HA, ABI}

In an aspect, a computer-implemented method for simulating flights according to this application may further comprise the following operations performed by the one or more computing devices: determining a current state of the one or more flights to be simulated based on the determined probabilities for the one or more flight parameters; determining a next state of the one or more flights to be simulated based on the current state; and outputting one or more evaluation parameters associated with the next state of the one or more flights to be simulated. In an aspect, the next state of the one or more flights to be simulated is determined based only on the current state (e.g. according to a Markov chain model). In an aspect, the state includes one or more of the following information associated with the one or more flights to be simulated: airport status, flight route status, aircraft status, or weather status. In an aspect, the one or more evaluation parameters include at least one or more of the following parameters associated with the one or more flights to be simulated: aircraft gas consumption, flight delay with respect to flight schedule, number of conflicts between aircrafts, weather condition, or airport occupancy. In an aspect, the one or more flight parameters include at least one or more of the following parameters associated with the one or more flights to be simulated: aircraft speed, aircraft direction of propagation, wind speed affecting the aircraft during propagation, flight level, or airport occupancy. In an aspect, the next state is temporally shifted to a later time with respect to the current state.

FIG. 4B shows the collaborations between each component of the simulation system 300. The simulation may be initialized 402 by obtaining the required flight data 115, 116 and pre-processing the flight data in a manner that it can be used in the simulation. For example, some not needed information may be deleted or labeled as to be ignored during the simulation. In order to get a satisfactory simulation result, the simulation device 302 may run several times until a termination condition has reached as determined by a statistical information recorder 409. The termination conditions may be: (1) reach a fixed number of iterations or (2) the statistical result tends to converge or no longer have a significant change.

Weather condition may have impact on air traffic. In this weather simulation, one may represent weather space with a 3D-lattice covering the whole area being simulated. One may estimate the weather conditions in each lattice according to historical flight route weather data. One may include several types of weather conditions such as: (1) wind speed and direction, (2) cloud, and/or (3) thunder. The system 300 also allows more weather conditions as long as those new conditions had appeared in historical data. The weather space may be denoted by:

W_{x,y,x}={WS, WD, CL, TH},

where WS is the wind speed and the wind direction (WD) is represented by the angle between the north and the wind direction. CL is a binary value that indicates whether the lattice is cloudy or not. Aircraft should avoid the cloudy lattice. TH is also a binary value that indicates the existence of a thunder in the lattice. Aircrafts may not only avoid thunder lattice but also avoid nearby lattices that surround the thunder lattice. The wind speed and direction of high altitude may tend to be static and change only according to seasonal changes. The seasonal wind speed and direction can be learned from historical flight and weather data.

The low altitude wind speed and direction may tend to be (pseudo-)random, especially the wind speed and direction in airport. As aircrafts usually do not perform landings and departures along the wind direction when the wind speed is higher than a safety threshold, the wind speed and direction will result different landing and departure procedures. The wind direction, wind speed, cloud, and thunder in each lattice may be generated according to yearly historical distributions in each lattice. For example, when a lattice had thunder for three times during the past year, then the probability that this lattice and near-by lattices will have a thunder would be 3/365, where 365 is the number of days during the past year. The “how many near-by lattices involved” can be a system parameter, controlling the area of influence. The whole weather condition may be simulated by probabilistic decision tree. By setting the length of each lattice, one may control the calculation speed and accuracy. The smaller the length is, the higher the simulation accuracy can be, and the calculation speed may become slower.

Once the weather condition is simulated in weather simulation 403, the system 300 starts to simulate airport condition 404 and flight route condition 405. The airport runway might be temporarily closed if wind speed is too high or there is a thunder area above the airport. The wind speed may determine which runway is to be used for landing and which runway is to be used for departure, followed by different landing and departure procedures. The flight route or part of the flight route might also be closed for weather reasons. In this operation, the system may determine which part of flight routes are available and which part of the flight routes should be avoided by aircrafts.

The air traffic controller simulation 406 may play the administration role in real flight traffic. In this system, the role of air traffic controller is simplified so that is performs the following actions: decide which flight departure/landing first, and solve conflict in flight routes. For example, the result may be to ask a flight to speed up or change flight level in order to avoid collisions to another flight. Two or more strategies for air traffic controller may be implemented: (1) first-come-first-serve: The flight comes first will have highest priority, other flight should wait until this flight release the corresponding resources such runway, flight routes, and so on. (2) Priority-based-serving: One assigns each flight a priority value. In a given time window, the flight with the highest priority will be served first. For example, we set the time window to 10 minutes. A flight with higher priority may land earlier than another flight with lower priority, even though the lower priority flight comes first. The safety distance is usually defined in flight route guidelines.

In single flight simulations 407, the simulation procedure of a single flight is performed. At first, the scheduled departure time of a flight is received, and then the departure time is calculated by scheduled departure time with a pseudo-random delay or ahead of time. The pseudo-randomness may be modeled by a Normal distribution, which is fitted by historical flight data. The flight level may also be estimated from historical flight data, considering, e.g., the departure weight, air pressure, and temperature. Once the estimated departure time and flight level is determined, the pilot may make an application to the air traffic controller. After getting an approval or adjustment advise from the air traffic controller, the flight may depart on the estimated departure time. Before passing through the first flight route point, the flight may follow a specific route called SID (standard instrument departure). The SID is defined by airport and all flight should exactly follow this route. FIG. 2A shows a sample flight from an airport to another airport. The position of this flight in SID is also calculated from historical data. Once the flight is passing the first flight route point, it should fly with a static speed and level unless the air traffic controller asks the flight to change speed or level to avoid congestions or collisions. The flight will keep this status until starting to landing. The flight position during this period may be calculated by the current speed and heading direction.

Usually, the flight may start the landing procedure when it passes through the last flight route point. Similar to SID, the landing procedure also may need to follow a pre-defined route. The flight position in route may also be calculated from historical data, considering the landing weight, air pressure, wind speed, wind direction, and temperature. The pilot may make a landing application once the flight is ready. The approval should also come from the air traffic controller. Similarly, the air traffic controller may do a rule checking procedure to check the congestion situation, availability of the runway, and flight priority. The flight may start to land on the runway when all the checking is done. Now, the single flight simulation has finished.

The flight simulation may be performed for a number (e. g, 100,000 or more) of flights in parallel. The difference between large-scaled flight and single flight may reside in the air traffic controller. The air traffic controller may get busy when the number of flights is increasing. The air traffic controller may make sure that all the flights are operating smoothly by applying a suitable rule. The results (e.g. evaluation parameters) of the simulation may be display in a simulation report (408).

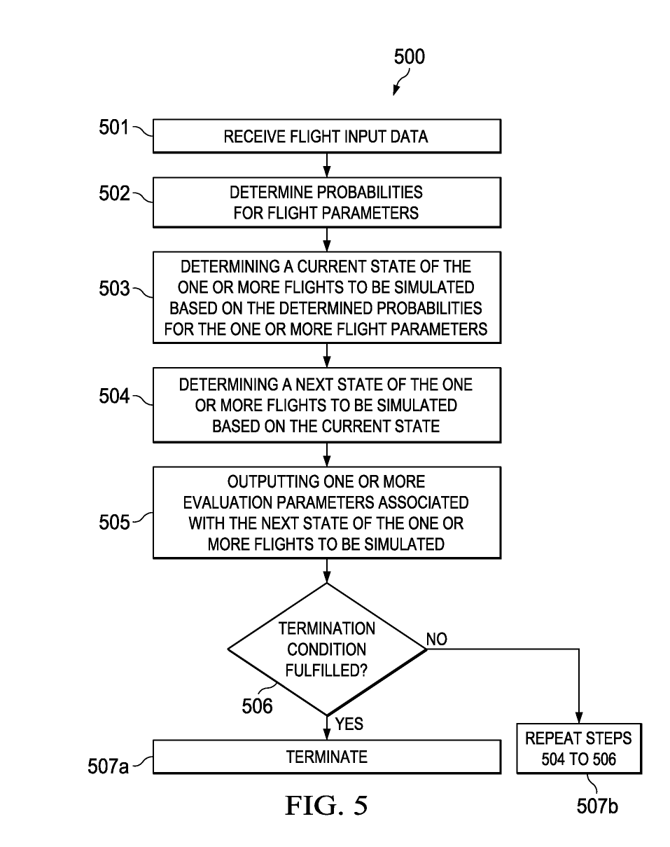

FIG. 5 illustrates an exemplary method 500 for simulating one or more flights performed by system 300. At 501, flight input data is received. The flight input data may include the flight information for one or more flights to be simulated and historical flight information for historical flights. The flight information may include at least one of: aircraft information, flight schedule information, airport information, flight route information, or weather information. The historical flight information may include at least one of the following information for the historical flights: aircraft information, flight schedule information, airport information, flight route information, or weather information.

At 502, probabilities for flight parameters are determined. For example, operation 502 may include determining, based on the flight information and the historical flight information, probabilities for one or more flight parameters of the one or more flights to be simulated. For example, the probabilities are determined using a probabilistic decision tree model.

At 503, a current state of the one or more flights to be simulated is determined based on the determined probabilities for the one or more flight parameters. For example, the current state may include one or more of the following information associated with the one or more flights to be simulated: airport status, flight route status, aircraft status, or weather status. For example, the state may be an aggregation of the one or more flight parameters. For example, the one or more flight parameters include at least one or more of the following parameters associated with the one or more flights to be simulated: aircraft speed, aircraft direction of propagation, wind speed affecting the aircraft during propagation, flight level, or airport occupancy.

At 504, a next state of the one or more flights to be simulated is determined based on the current state. For example, the next state of the one or more flights to be simulated is determined based on the current state according to a Markov chain model. For example, the next state may include one or more of the following information associated with the one or more flights to be simulated: airport status, flight route status, aircraft status, or weather status. For example, the next state may be an aggregation of updated versions of the one or more flight parameters.

At 505, one or more evaluation parameters associated with the next state of the one or more flights to be simulated are outputted. For example, the one or more evaluation parameters include at least one or more of the following parameters associated with the one or more flights to be simulated: aircraft gas consumption, flight delay with respect to flight schedule, number of conflicts between aircrafts, weather condition, or airport occupancy. For example, the evaluation parameters may be outputted after the determination of each of the current and the next state.

At 506, it is determined if the termination condition is fulfilled. If the condition is fulfilled, then the process 500 is terminated at 507a, and if the condition is not fulfilled, then the process 500 is continued by repeating operations 504 to 506 at 507b.

This application provides a system and method for large scaled flight schedule simulation. With this system, both airline company and air traffic authority can improve their ability to evaluate current and future flight status. The system may also provide a wide range of indicators to help quantitative analysis on flight route congestions. The system can be further integrated as an evaluation module into a flight schedule optimization system.

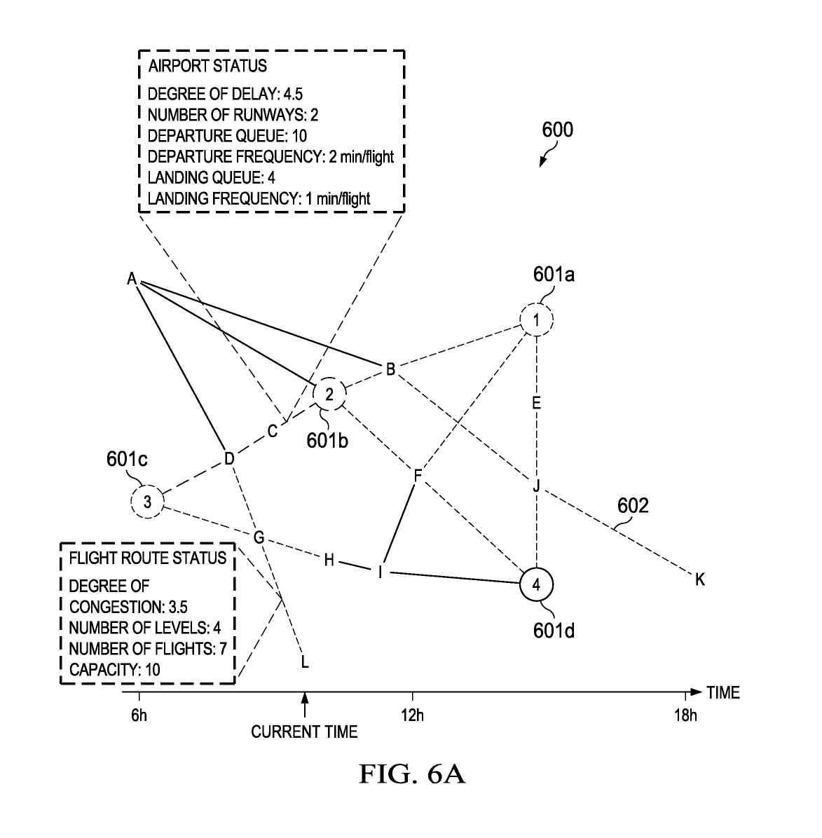

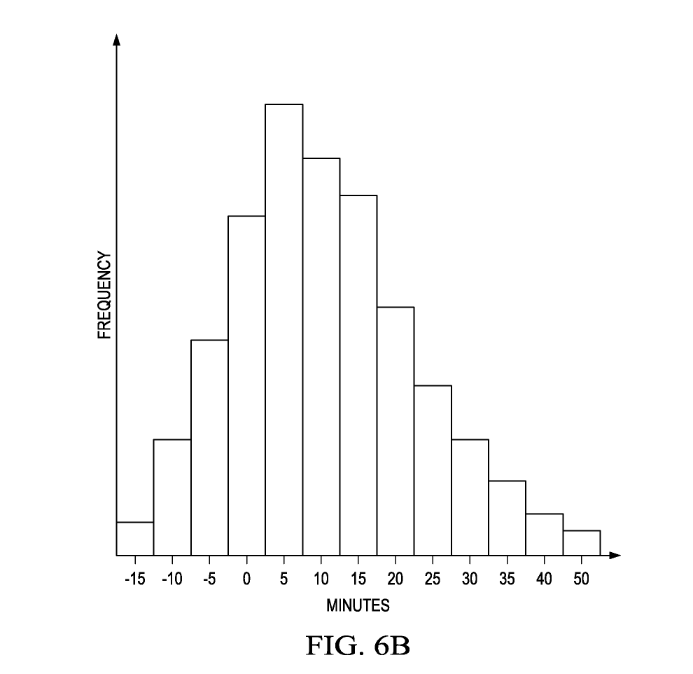

FIG. 6A illustrates an exemplary simulation output 600 for one or more simulated flights. In FIG. 6A 4 airports 601a, 601b, 601c, 601d are illustrated together with several flights on a flight route 602. The existing flight schedules among those airports are evaluated. Given all the inputs (flight schedules, historical data, etc), the simulation system 300 may start to simulate the air traffic (airport, flight route and flight) from the first flight departures until the last flight arrives its destination. During the simulation, the simulation system 300 can display the status of airport, flight route and flight in a player or screen (in FIG. 6A, the airport 601b may be affected by heavy delay or congestion, the airport 601d may show most of the flights on time and no congestion, the airports 601a, 601c may have a status in between). By user-initiated clicking on the airports and flight route the simulation may provide the detailed status (e.g. the evaluation parameters). This simulation output (e.g. in a GUI) may help to visualize the status of the whole air traffic.

FIG. 6B illustrates a delay distribution of a flight for one thousand runs of the simulation. If one runs the simulation multiple times, say 1000 times, each time the simulation result may be different, because of the random factors in the simulation procedure (e.g. weather). The simulation may provide histograms to see the statistical output of the evaluation. For example, in this figure, a delay distribution of a flight of one thousand runs is showed. The x-axis means the number of minutes this flight had delayed, and the y-axis means the frequency of corresponding delay time. With this histogram, the simulation can also calculate the average delay time of this flight. Similarly, the simulation can draw this kind of histogram for each flight route and each airport. If the simulation finds that a flight has a very high average delay time, the simulation or the developer can start to investigate the reasons behind this, e.g., a busy airport or busy flight route. Then, output of the simulation can (e.g. automatically) be used to (e.g. automatically or without any further user interaction with the simulation) take some actions to solve issues, possible actions could be: (1) move this flight to another time slot; (2) add new flight route; (3) increase the capacity of an airport. Before performing these actions to the real world, these actions may be performed in the simulation to evaluate the effect of these actions on the output of the simulation. For example, before adding a new flight route to the real world, the simulation can first add this route to our system and re-run the simulation with the same flight schedules, this may help the developers to see if this action is helpful or not. The output of the simulation may also automatically (e.g., without any further user interaction with the simulation) be fed back to an aircraft, an airport or a flight controller to perform at least one of these actions.

The preceding figures and accompanying description illustrate example processes and computer implementable techniques. But example distributed computing system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, example distributed computing system 100 may use processes with additional operations, fewer operations, and/or different operations, so long as the methods remain appropriate. Process operations may also be executed and described software/services may also execute on various components of example distributed computing system 100 so long as the methods remain appropriate. Moreover, although features may be described above as acting in certain combinations and even initially claimed as such, one or more features from a claimed combination can in some cases be excised from the combination, and the claimed combination may be directed to a sub-combination or variation of a sub-combination.

In other words, although this disclosure has been described in terms of certain aspects or embodiments and generally associated methods, alterations and permutations of these aspects, embodiments and methods will be apparent to those skilled in the art.

What is claimed is:

1. A computer-implemented method for simulating flights, the method comprising the following operations performed by one or more computing devices:
receiving flight information for one or more flights to be simulated;
receiving historical flight information for historical flights;
determining, based on the flight information and the historical flight information, probabilities for one or more flight parameters of the one or more flights to be simulated;
determining a current state of the one or more flights to be simulated based on the determined probabilities for the one or more flight parameters;
determining a next state of the one or more flights to be simulated based on the current state; and
outputting one or more evaluation parameters associated with the next state of the one or more flights to be simulated.

2. The method of claim 1, wherein the flight information includes at least one of: aircraft information, flight schedule information, airport information, flight route information, or weather information

3. The method of claim 1, wherein the historical flight information includes at least one of the following information for historical flights: aircraft information, flight schedule information, airport information, flight route information, or weather information.

4. The method of claim 3, wherein the weather information includes at least one of the following information associated with a portion of the flight route of the historical flight: wind speed, wind direction, air pressure, cumulonimbus, or temperature.

5. The method of claim 1, wherein the probabilities are determined using a probabilistic decision tree model.

6. The method of claim 1, wherein the next state of the one or more flights to be simulated is determined based only on the current state, or wherein the next state of the one or more flights to be simulated is determined based on the current state according to a Markov chain model.

7. The method of claim 1, the method further comprising automatically performing at least one of:
moving a real flight to another time slot, adding a new real flight route, or increasing a capacity of a real airport.

8. The method of claim 1, wherein the state includes one or more of the following information associated with the one or more flights to be simulated: airport status, flight route status, aircraft status, or weather status.

9. The method of claim 1, wherein one or more evaluation parameters include at least one or more of the following parameters associated with the one or more flights to be simulated: aircraft gas consumption, flight delay with respect to flight schedule, number of conflicts between aircrafts, weather condition, or airport occupancy.

10. The method of claim 1, wherein one or more flight parameters include at least one or more of the following parameters associated with the one or more flights to be simulated: aircraft speed, aircraft direction of propagation, wind speed affecting the aircraft during propagation, flight level, or airport occupancy.

11. The method of claim 1, wherein the next state is temporally shifted to a later time with respect to the current state.

12. A computer program product encoded on a non-transitory, tangible storage medium, the product comprising computer readable instructions for causing one or more computers to perform operations for simulating flights, the operations comprising:
receiving flight information for one or more flights to be simulated;
receiving historical flight information for historical flights;
determining, based on the flight information and the historical flight information, probabilities for one or more flight parameters of the one or more flights to be simulated;
determining a current state of the one or more flights to be simulated based on the determined probabilities for the one or more flight parameters;
determining a next state of the one or more flights to be simulated based on the current state; and
outputting one or more evaluation parameters associated with the next state of the one or more flights to be simulated.

13. The computer program product of claim 12, wherein the flight information includes at least one of: aircraft information, flight schedule information, airport information, flight route information, or weather information

14. The computer program product of claim 12, wherein the historical flight information includes at least one of the following information for historical flights: aircraft information, flight schedule information, airport information, flight route information, or weather information.

15. The computer program product of claim 12, wherein one or more flight parameters include at least one or more of the following parameters associated with the one or more flights to be simulated: aircraft speed, aircraft direction of propagation, wind speed affecting the aircraft during propagation, flight level, or airport occupancy.

16. The computer program product of claim 12, wherein the probabilities are determined using a probabilistic decision tree model and wherein the next state of the one or more flights to be simulated is determined based on the current state according to a Markov chain model.

17. A system for simulating flights, the system comprising:
one or more computers; and
a computer-readable medium coupled to the one or more computers having instructions stored thereon which, when executed by the one or more computers, cause the one or more computers to perform operations, the operations comprising:
receiving flight information for one or more flights to be simulated;
receiving historical flight information for historical flights;
determining, based on the flight information and the historical flight information, probabilities for one or more flight parameters of the one or more flights to be simulated;
determining a current state of the one or more flights to be simulated based on the determined probabilities for the one or more flight parameters;
determining a next state of the one or more flights to be simulated based on the current state; and
outputting one or more evaluation parameters associated with the next state of the one or more flights to be simulated.

18. The system of claim 17, wherein the flight information includes at least one of:
aircraft information, flight schedule information, airport information, flight route information, or weather information, and wherein the historical flight information includes at least one of the following information for historical flights: aircraft information, flight schedule information, airport information, flight route information, or weather information.

19. The system of claim 17, wherein one or more flight parameters include at least one or more of the following parameters associated with the one or more flights to be simulated: aircraft speed, aircraft direction of propagation, wind speed affecting the aircraft during propagation, flight level, or airport occupancy.

20. The system of claim 17, wherein the probabilities are determined using a probabilistic decision tree model and wherein the next state of the one or more flights to be simulated is determined only based on the current state and not on any earlier state before the current state.
